(19) United States
(12) Patent Application Publication
(10) Pub. No.: US 2008/0112593 A1
(43) Pub. Date: May 15, 2008

(54) Automated method and apparatus for robust image object recognition and/or classification using multiple temporal views

(76) Inventors: Edward R. Ratner, Los Altos, CA (US); Schuyler A. Cullen, Mt. View, CA (US)

Correspondence Address: OKAMOTO & BENEDICTO, LLP, P.O. BOX 641330, SAN JOSE, CA, 95164, US

(21) Appl. No.: 11/981,244

(22) Filed: Oct. 30, 2007

Related U.S. Application Data
(60) Provisional application No. 60/864,284, filed on Nov. 3, 2006.

(51) Int. Cl. G06K 9/00

(52) U.S. Cl. 382/103

(57) ABSTRACT

An automated method for classifying an object in a sequence of video frames. The object is tracked in multiple frames of the sequence of video frame, and feature descriptors are determined for the object for each of the multiple frames. Multiple classification scores are computed by matching said feature descriptors for the object for each of the multiple frames with feature descriptors for a candidate class in a classification database. Said multiple classification scores are aggregated to generate an estimated probability that the object is a member of the candidate class. Other embodiments, aspects and features are also disclosed.

### CROSS-REFERENCE TO RELATED APPLICATIONS

The present application claims the benefit of U.S. Provisional Patent Application No. 60/864,284, entitled “Apparatus and Method For Robust Object Recognition and Classification Using Multiple Temporal Views”, filed Nov. 3, 2006, by inventors Edward Ratner and Schuyler A. Cullen, the disclosure of which is hereby incorporated by reference.

### BACKGROUND

1. Field of the Invention

The present application relates generally to digital video processing and more particularly to automated recognition and classification of image objects in digital video streams.

2. Description of the Background Art

Video has become ubiquitous on the Web. Millions of people watch video clips everyday. The content varies from short amateur video clips about 20 to 30 seconds in length to premium content that can be as long as several hours. With broadband infrastructure becoming well established, video viewing over the Internet will increase.

### BRIEF DESCRIPTION OF THE DRAWINGS

FIG. 1 is a schematic diagram depicting an automated method using software or hardware circuit modules for robust image object recognition and classification in accordance with an embodiment of the invention.

FIG. 2 shows five frames in an example video sequence.

FIG. 3 shows a particular object (the van) tracked through the five frames of FIG. 2.

FIG. 4 shows an example extracted object (the van) with feature points in accordance with an embodiment of the invention.

FIG. 5 is a schematic diagram of an example computer system or apparatus which may be used to execute the automated procedures for robust image object recognition and/or classification in accordance with an embodiment of the invention.

FIG. 6 is a flowchart of a method of object creation by partitioning of a temporal graph in accordance with an embodiment of the invention.

FIG. 7 is a flowchart of a method of creating a graph in accordance with an embodiment of the invention.

FIG. 8 is a flowchart of a method of cutting a partition in accordance with an embodiment of the invention.

FIG. 9 is a flowchart of a method of performing an optimum or near optimum cut in accordance with an embodiment of the invention.

FIG. 10 is a flowchart of a method of mapping object pixels in accordance with an embodiment of the invention.

FIG. 11 is a schematic diagram showing an example partitioned temporal graph for illustrative purposes in accordance with an embodiment of the invention.

### DETAILED DESCRIPTION

Video watching on the Internet is, today, a passive activity. Viewers typically watch video streams from beginning to end much like they do with television. In contrast, with static Web pages, users often search for text of interest to them and then go directly to that portion of the Web page.

Applicants believe that it would be highly desirable, given an image or a set of images of an object, for users to be able to search for the object, or type of object, in a single video stream or a collection of video streams. However, for such a capability to be reliably achieved, a robust technique for object recognition and classification is required.

A number of classifiers have now been developed that allow an object under examination to be compared with an object of interest or a class of interest. Some examples of classifier/matcher algorithms are Support Vector Machines (SVM), nearest-neighbor (NN), Bayesian networks, and neural networks. The classifier algorithms are applied to the subject image.

In previous techniques, the classifiers operate by comparing a set of properties extracted from the subject image with the set of properties similarly computed on the object(s) of interest that is (are) stored in a database. These properties are commonly referred to, as local feature descriptors. Some examples of local feature descriptors are scale invariant feature transforms (SIFT), gradient location and orientation histograms (GLOH) and shape contexts. A large number of local feature descriptors are available and known in the art.

The local feature descriptors may be computed on each object separately in the image under consideration. For example, SIFT local feature descriptors may be computed on the subject image and the object of interest. If the properties are close in some metric, then the classifier produces a match. To compute the similarity measure, the SVM matcher algorithm may be applied to the set of local descriptor feature vectors, for example.

The classifier is trained on a series of images containing the object of interest (the training set). For the most robust matching, the series contains the object viewed from many different viewing conditions such as viewing angle, ambient lighting, and different types of cameras.

However, even though multiple views and conditions are used in the training set, previous classifiers still often fail to produce a match. Failure to produce a match typically occurs when the object of interest in the subject frame does not appear in precisely or almost the same viewing conditions as in at least one of the images in the training set. If the properties extracted from the object of interest in the subject frame vary too much from the properties extracted from the object in the training set, then the classifier fails to produce a match.

The present application discloses a technique to more robustly perform object identification and/or classification. Improvement comes from the capability to go beyond applying the classifier to an object in a single subject frame. Instead, a capability is provided to apply the classifier to the object of interest moving through a sequence of frames and to statistically combine the results from the different frames in a useful manner.

Given that the object of interest is tracked through multiple frames, the object appears in multiple views, each one somewhat different from the others. Since the matching confidence level (similarity measure) obtained by the classifier depends heavily on the difference between the viewed image and the training set, having different views of the same object in different frames results in varying matching quality based on different features being available for a match. A statistical averaging of the matching results may therefore be produced by combining the results from the different subject frames. Advantageously, this significantly improves the chance of correct classification (or identification) by increasing the signal-to-noise ratio.

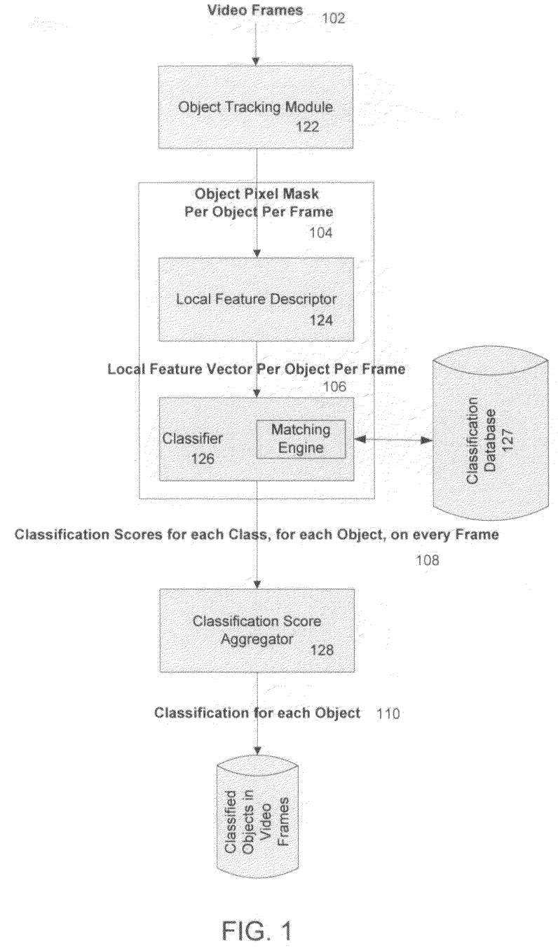

FIG. 1 is a schematic diagram depicting an automated method using software or hardware circuit modules for robust object recognition and classification in accordance with an embodiment of the invention. In accordance with this embodiment, multiple video frames are input 102 into an object tracking module 122.

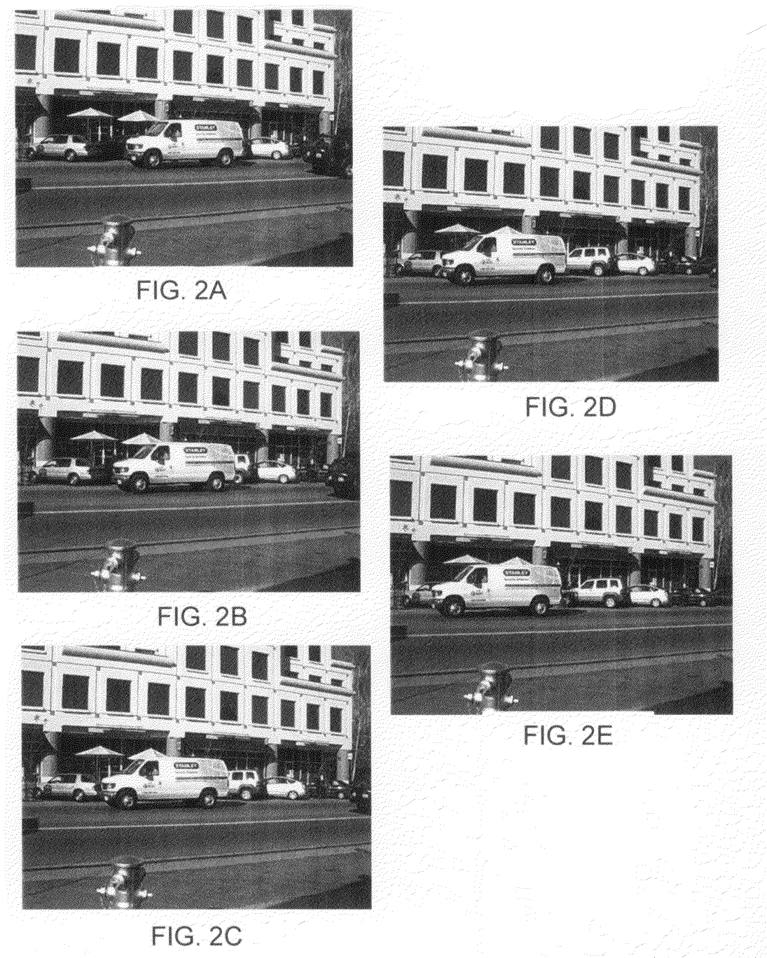

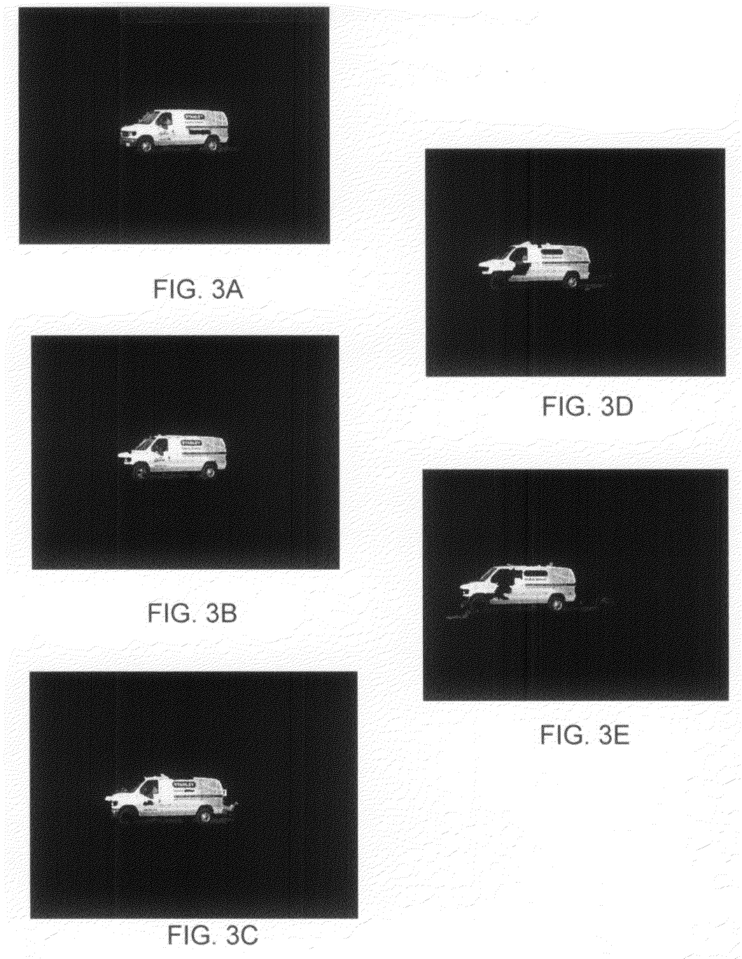

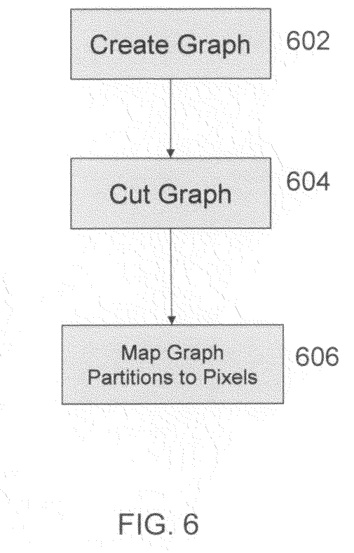

The object tracking module 122 identifies the pixels belonging to each object in each frame. An example video sequence is shown in FIGS. 2A, 2B, 2C, 2D and 2E. An example object (the van) as tracked through the five frames of FIGS. 2A, 2B, 2C, 2D and 2E are shown in FIGS. 3A, 3B, 3C, 3D and 3E. Tracking of objects by the object tracking module 122 may be implemented, for example, by optical pixel flow analysis, or by object creation via partitioning of a temporal graph (as described further below in relation to FIGS. 6-11).

The object tracking module 122 may be configured to output an object pixel mask per object per frame 104. An object pixel mask identifies the pixels in a frame that belong to an object. The object pixel masks may be input into a local feature descriptor module 124.

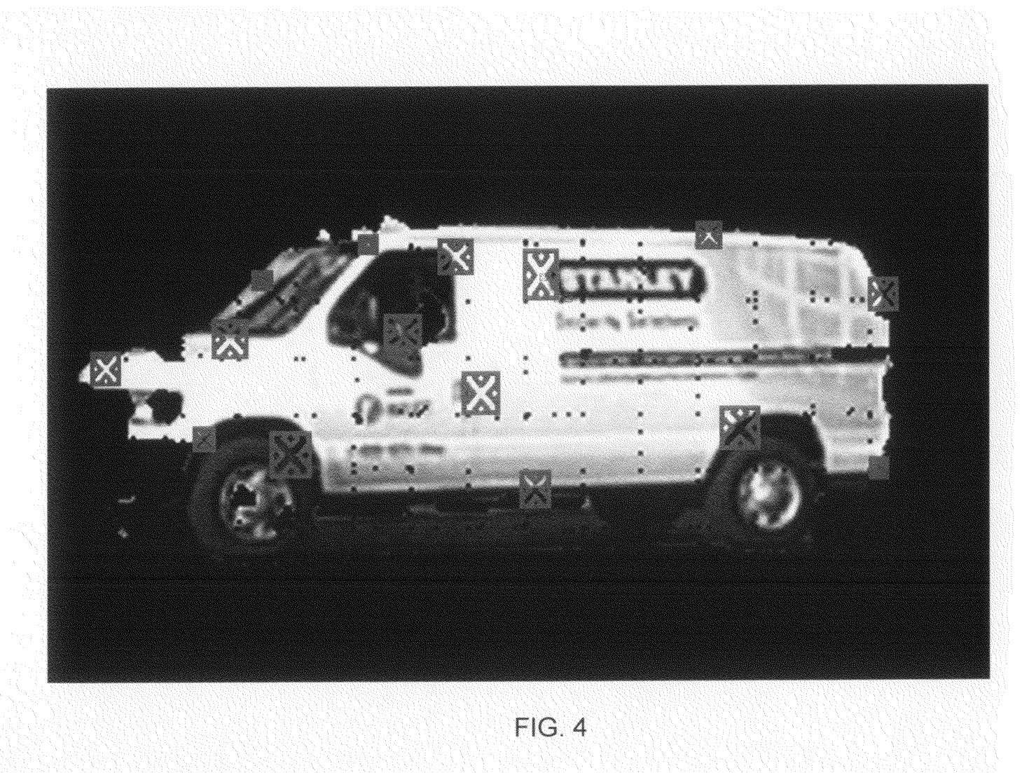

The local feature descriptor module 124 may be configured to apply a local feature descriptor algorithm, for example, one of those mentioned above (i.e. scale invariant feature transforms (SIFT), gradient location and orientation histograms (GLOH) and shape contexts). For instance, a set of SIFT feature vectors may be computed from the pixels belonging to a given object. In general, a set of feature vectors will contain both local and global information about the object. In a preferred embodiment, features may be selected at random positions and size scales. For each point randomly selected, a local descriptor may be computed and stored as a feature vector. Such local descriptors are known in the art. The set of local descriptors calculated over the selected features in the object are used together for matching. An example extracted image with feature points is shown in FIG. 4. The feature points in FIG. 4 are marked with larger sizes corresponding to coarser scales. The local feature descriptor module 124 may output a set of local feature vectors per object 106.

The set of local feature vectors for an object, obtained for each frame, may then be fed into a classifier module 126. The classifier module 126 may be configured to apply a classifier and/or matcher algorithm.

For example, the set of local feature vectors per object 106 from the local feature descriptor module 124 may be input by the classifier module 126 into a Support Vector Machine (SVM) engine or other matching engine. The engine may produce a score or value for matching with classes of interest in a classification database 127. The classification database 127 is previously trained with various object classes. The matching engine is used to match the set of feature vectors to the classification database 127. For example, in order to identify a “van” object, the matching engine may return a similarity measure xᵢ for each candidate object i in an image (frame) relative to the “van” class. The similarity measure may be a value ranging from 0 to 1, with 0 being not at all similar, and 1 being an exact match. For each value of xᵢ, there is a corresponding value of pi, which is the estimated probability that the given object i is a van.

As shown in FIG. 1, the classifier module 126 may be configured to output the similarity measures (classification scores for each class, for each object, on every frame) 108 to a classification score aggregator module 128. The classification score aggregator module 128 may be configured to use the scores achieved for a given object from all the frames in which the given object appears so as to make a decision as to whether or not a match is achieved. If a match is achieved, then the given object is considered to have been successfully classified or identified. The classification for the given object 110 may be output by the classification score aggregator module 128.

For example, given the example image frames in FIGS. 2A through 2E, Table 1 shown below contains the similarity scores and the associated probabilities that the given object shown in FIGS. 3A through 3E is a member of the “van” class. As discussed in further detail below, the probability determined by association with the similarity score may be compared to a threshold. If the probability determined exceeds (or equals to or exceeds) the threshold, then the given object may be deemed as being in the class. In this way, the objects in the video frames may be classified or identified.

TABLE 1

| Frame # | Similarity (Van class) | Probability (Van class) |
|---|---|---|
| 40 | 0.65 | 0.73 |
| 41 | 0.61 | 0.64 |
| 42 | 0.62 | 0.65 |
| 43 | 0.59 | 0.63 |
| 44 | 0.58 | 0.62 |

In accordance with a first embodiment, a highest score achieved on any of the frames may be used. For the particular example given in Table 1, the score from frame 40 would be used. In that case, the probability of the given object being a van would be determined to be 73%. This determined probability may then be compared against a threshold probability. If the determined probability is above (or is equal to or above) the threshold probability, then the classification score aggregator 128 may identify or classify the given object as a van and that classification for the given object 110 may be output.

In accordance with a second embodiment, the average of scores from all the frames with the given object may be used. For the particular example given in Table 1, the average similarity score is 0.61, which corresponds to a probability of 64%. If this determined probability is above (or is equal to or above) the threshold probability, then the classification score aggregator 128 may identify or classify the given object as a van and that classification for the given object 110 may be output.

In accordance with a third embodiment, a median score of the scores from all the frames with the given object may be used. For the particular example given in Table 1, the median similarity score is 0.61, which corresponds to a probability of 64%. If this determined probability is above (or is equal to or above) the threshold probability, then the classification score aggregator 128 may identify or classify the given object as a van and that classification for the given object 110 may be output.

In accordance with a fourth and preferred embodiment, a Bayesian inference may be used to get a better estimate of the probability that the object is a member of the class of interest. The Bayesian inference is used to combine or fuse the data from the multiple frames, where the data from each frame is viewed as an independent measurement of the same property.

Using Bayesian statistics, if we have two measurements of a same property with probabilities p1 and p2, then the combined probability p12=p1p2/[p1p2+(1−p1)(1−p2)]. Similarly, if we have n measurements of a same property with probabilities p1, p2, p3, . . . , pn, then the combined probability p1n=p1p2p3 . . . pn/[p1p2p3 . . . pn+(1−p1)(1−p2)(1−p3) . . . (1−pn)]. If this combined probability is above (or is equal to or above) the threshold probability, then the classification score aggregator 128 may identify or classify the given object as a van and that classification for the given object 110 may be output.

For the particular example given in Table 1, the probability that the object under consideration is a van is determined, using Bayesian statistics, to be 96.1%. This probability is higher under Bayesian statistics because the information from multiple frames reinforces each other to give a very high confidence that the object is a van. Thus, if the threshold for recognition is, for example, 95%, which is not reached by analyzing the data in any individual frame, this threshold would still be passed in our example due to the higher confidence from the multiple frame analysis using Bayesian inference.

Advantageously, the capability to use multiple instances of a same object to statistically average out the noise may result in significantly improved performance for an image object classifier or identifier. The embodiments described above provide example techniques for combining the information from multiple frames. In the preferred embodiment, a substantial advantage is obtainable when the results from a classifier are combined from multiple frames.

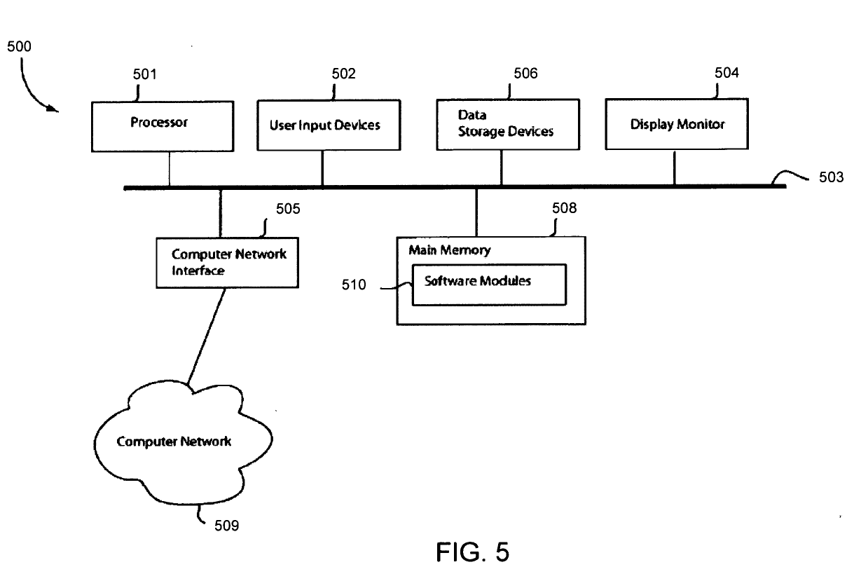

FIG. 5 is a schematic diagram of an example computer system or apparatus 500 which may be used to execute the automated procedures for robust object recognition and/or classification in accordance with an embodiment of the invention. The computer 500 may have less or more components than illustrated. The computer 500 may include a processor 501, such as those from the Intel Corporation or Advanced Micro Devices, for example. The computer 500 may have one or more buses 503 coupling its various components. The computer 500 may include one or more user input devices 502 (e.g., keyboard, mouse), one or more data storage devices 506 (e.g., hard drive, optical disk, USB memory), a display monitor 504 (e.g., LCD, flat panel monitor, CRT), a computer network interface 505 (e.g., network adapter, modem), and a main memory 508 (e.g., RAM).

In the example of FIG. 5, the main memory 508 includes software modules 510, which may be software components to perform the above-discussed computer-implemented procedures. The software modules 510 may be loaded from the data storage device 506 to the main memory 508 for execution by the processor 501. The computer network interface 505 may be coupled to a computer network 509, which in this example includes the Internet.

FIG. 6 depicts a high-level flow chart of an object creation method which may be utilized by the object tracking module 122 in accordance with an embodiment of the invention.

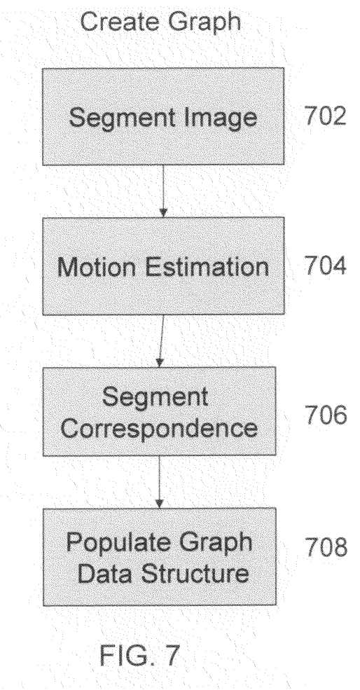

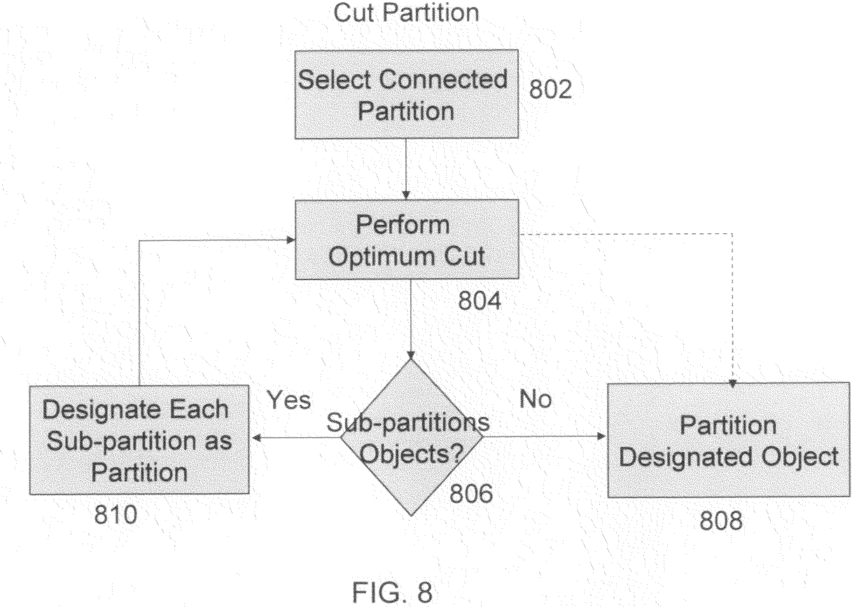

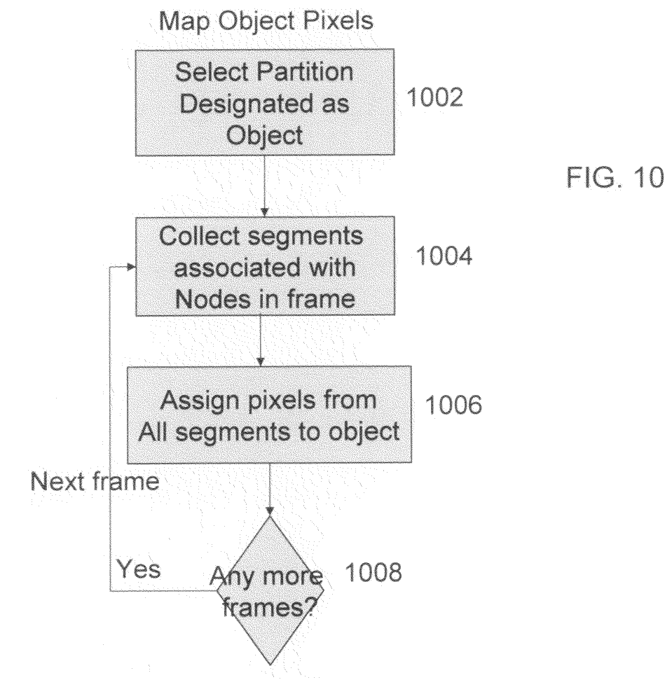

In a first phase, shown in block 602 of FIG. 6, a temporal graph is created. Example steps for the first phase are described below in relation to FIG. 7. In a second phase, shown in block 604, the graph is cut. Example steps for the second phase are described below in relation to FIG. 8. Finally, in a third phase, shown in block 606, the graph partitions are mapped to pixels. Example steps for the third phase are described below in relation to FIG. 10.

FIG. 7 is a flowchart of a method of creating a temporal graph in accordance with an embodiment of the invention. Per block 702 of FIG. 7, a given static image is segmented to create image segments. Each segment in the image is a region of pixels that share similar characteristics of color, texture, and possible other features. Segmentation methods include the watershed method, histogram grouping and edge detection in combination with techniques to form closed contours from the edges.

Per block 704, given a segmentation of a static image, the motion vectors for each segment are computed. The motion vectors are computed with respect to displacement in a future frame/frames or past frame/frames. The displacement is computed by minimizing an error metric with respect to the displacement of the current frame segment onto the target frame. One example of an error metric is the sum of absolute differences. Thus, one example of computing a motion vector for a segment would be to minimize the sum of absolute difference of each pixel of the segment with respect to pixels of the target frame as a function of the segment displacement.

Per block 706, segment correspondence is performed. In other words, links between segments in two frames are created. For instance, a segment (A) in frame 1 is linked to a segment (B) in frame 2 if segment A, when motion compensated by its motion vector, overlaps with segment B. The strength of the link is preferably given by some combination of properties of Segment A and Segment B. For instance, the amount of overlap between motion-compensated Segment A and Segment B may be used to determine the strength of the link, where the motion-compensated Segment A refers to Segment A as translated by a motion vector to compensate for motion from frame 1 to frame 2. Alternatively, the overlap of the motion-compensated Segment B and Segment A may be used to determine the strength of the link, where the motion-compensated Segment B refers to Segment B as translated by a motion vector to compensate for motion from frame 2 to frame 1. Or a combination (for example, an average or other mathematical combination) of these two may be used to determine the strength of the link.

Finally, per block 708, a graph data structure is populated so as to construct a temporal graph for N frames. In the temporal graph, each segment forms a node in the temporal graph, and each link determined per block 706 forms a weighted edge between the corresponding nodes.

Once the temporal graph is constructed as discussed above, the graph may be partitioned as discussed below. The number of frames used to construct the temporal graph may vary from as few as two frames to hundreds of frames. The choice of the number of frames used preferably depends on the specific demands of the application.

FIG. 8 is a flowchart of a method of cutting a partition in the temporal graph in accordance with an embodiment of the invention. Partitioning a graph results in the creation of sub-graphs. Sub-graphs may be further partitioned.

In a preferred embodiment, the partitioning may use a procedure that minimizes a connectivity metric. A connectivity metric of a graph may be defined as the sum of all edges in a graph. A number of methods are available for minimizing a connectivity metric on a graph for partitioning, such as the “min cut” method.

After partitioning the original temporal graph, the partitioning may be applied to each sub-graph of the temporal graph. The process may be repeated until each sub-graph meets some predefined minimal connectivity criterion or satisfies some other statically-defined criterion. When the criterion (or criteria) is met, then the process stops.

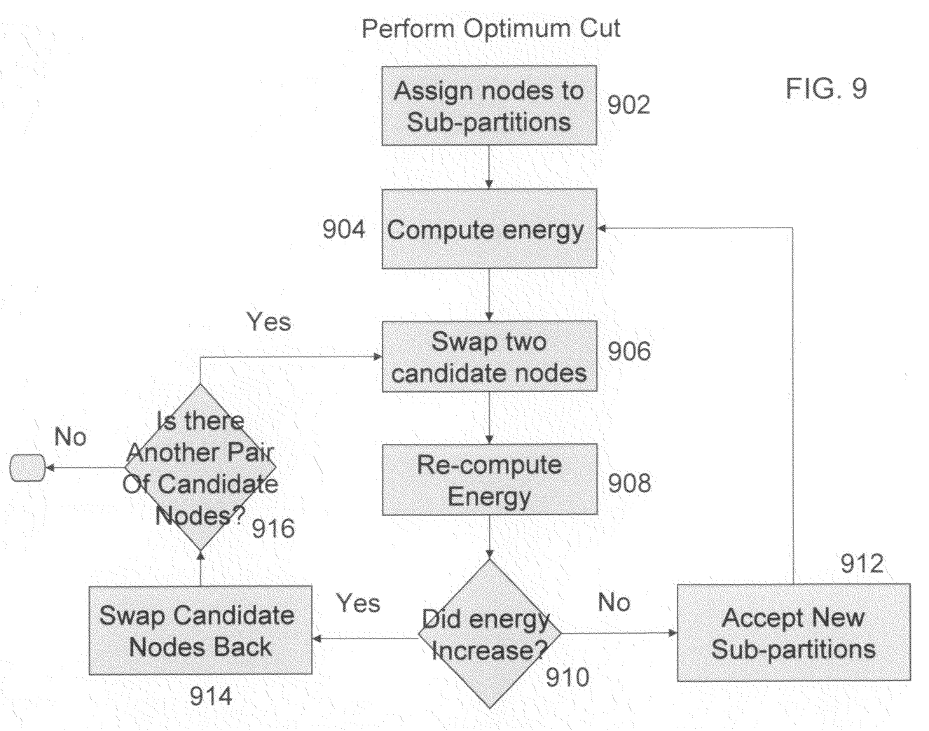

In the illustrative procedure depicted in FIG. 8, a connected partition is selected 802. An optimum or near optimum cut of the partition to create sub-graphs may then be performed per block 804, and information about the partitioning is then passed to a partition designated object (per the dashed line between blocks 804 and 808). An example procedure for performing an optimum or near optimum cut is further described below in relation to FIG. 9.

Per block 806, a determination may be made as to whether any of the sub-partitions (sub-graphs) have multiple objects and so require further partitioning. In other words, a determination may be made as to whether the sub-partitions do not yet meet the statically-defined criterion. If further partitioning is required (statically-defined criterion not yet met), then each such sub-partition is designated as a partition per block 810, and the process loops back to block 804 so as to perform optimum cuts on these partitions. If further partitioning is not required (statically-defined criterion met), then a partition designated object has been created per block 808.

At the conclusion of this method, each sub-graph results in a collection of segments on each frame corresponding to a coherently moving object. Such a collection of segments, on each frame, form outlines of coherently moving objects that may be advantageously utilized to create hyperlinks, or to perform further operations with the defined objects, such as recognition and/or classification. Due to this novel technique, each object as defined will be well separated from the background and from other objects around it, even if they are highly overlapped and the scene contains many moving objects.

FIG. 9 is a flowchart of a method of performing an optimum or near optimum cut in accordance with an embodiment of the invention. First, nodes are assigned to sub-partitions per block 902, and an energy is computed per block 904.

As shown in block 906, two candidate nodes may then be swapped. Thereafter, the energy is re-computed per block 908. Per block 910, a determination may then be made as to whether the energy increased (or decreased) as a result of the swap.

If the energy decreased as a result of the swap, then the swap did improve the partitioning, so the new sub-partitions are accepted per block 912. Thereafter, the method may loop back to step 904.

On the other hand, if the energy increased as a result of the swap, then the swap did not improve the partitioning, so the candidate nodes are swapped back (i.e. the swap is reversed) per block 914. Then, per block 916, a determination may be made as to whether there is another pair of candidate nodes. If there is another pair of candidate nodes, then the method may loop back to block 906 where these two nodes are swapped. If there is no other pair of candidate nodes, then this method may end with the optimum or near optimum cut having been determined.

FIG. 10 is a flowchart of a method of mapping object pixels in accordance with an embodiment of the invention. This method may be performed after the above-discussed partitioning procedure of FIG. 8.

In block 1002, selection is made of a partition designated as an object. Then, for each frame, segments associated with nodes of the partition are collected per block 1004. Per block 1006, pixels from all of the collected segments are then assigned to the object. Per block 1008, this is performed for each frame until there are no more frames.

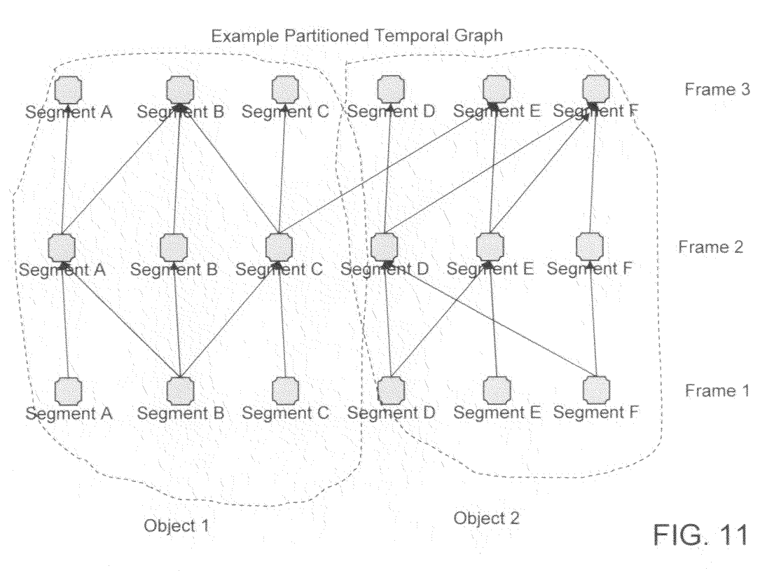

FIG. 11 is a schematic diagram showing an example partitioned temporal graph for illustrative purposes in accordance with an embodiment of the invention. This illustrative example depicts a temporal graph for six segments (Segments A through F) over three frames (Frames 1 through 3). The above-discussed links or edges between the segments are shown. Also depicted is illustrative partitioning of the temporal graph which creates two objects (Objects 1 and 2). As seen, in this example, the partitioning is such that Segments A, B, and C are partitioned to create Object 1, and Segments D, E and F are partitioned to create Object 2.

The methods disclosed herein are not inherently related to any particular computer or other apparatus. Various general-purpose systems may be used with programs in accordance with the teachings herein, or it may prove convenient to construct more specialized apparatus to perform the required method steps. In addition, the methods disclosed herein are not described with reference to any particular programming language. It will be appreciated that a variety of programming languages may be used to implement the teachings of the invention as described herein.

The apparatus to perform the methods disclosed herein may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories, random access memories, EPROMs, EEPROMs, magnetic or optical cards, or any type of media suitable for storing electronic instructions, and each coupled to a computer system bus or other data communications system.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. An automated method for classifying an object in a sequence of video frames, the method comprising:
tracking the object in multiple frames of the sequence of video frames;
determining feature descriptors for the object for each of the multiple frames;
computing multiple classification scores by matching said feature descriptors for the object for each of the multiple frames with feature descriptors for a candidate class in a classification database; and
aggregating said multiple classification scores to generate an estimated probability that the object is a member of the candidate class.

2. The method of claim 1, wherein said aggregating comprises determining a highest classification score among the multiple classification scores.

3. The method of claim 1, wherein said aggregating comprises determining an average classification score from the multiple classification scores.

4. The method of claim 1, wherein said aggregating comprises determining a median classification score from the multiple classification scores.

5. The method of claim 1, wherein said aggregating comprises using a Bayesian inference to determine a combined probability.

6. The method of claim 1, wherein the object is tracked by partitioning of a temporal graph.

7. The method of claim 1, wherein the feature descriptors for the object are determined by applying scale invariant feature transforms.

8. The method of claim 1, wherein the classification scores are computed using a support vector machine engine.

9. The method of claim 1, wherein the object is tracked by partitioning of a temporal graph.

10. A computer apparatus configured to classify an object in a sequence of video frames, the apparatus comprising:
a processor for executing computer-readable program code;
memory for storing in an accessible manner computer-readable data;
computer-readable program code configured to track the object in multiple frames of the sequence of video frames;
computer-readable program code configured to determine feature descriptors for the object for each of the multiple frames;
computer-readable program code configured to calculate multiple classification scores by matching said feature descriptors for the object for each of the multiple frames with feature descriptors for a candidate class in a classification database; and
computer-readable program code configured to aggregate said multiple classification scores to generate an estimated probability that the object is a member of the candidate class.

11. The apparatus of claim 10, wherein said multiple classification scores are aggregated by determining a highest classification score among the multiple classification scores.

12. The apparatus of claim 10, wherein said multiple classification scores are aggregated by determining an average classification score from the multiple classification scores.

13. The apparatus of claim 10, wherein said multiple classification scores are aggregated by determining a median classification score from the multiple classification scores.

14. The apparatus of claim 10, wherein said multiple classification scores are aggregated by using a Bayesian inference to determine a combined probability.

15. The apparatus of claim 10, wherein the object is tracked by partitioning of a temporal graph.

16. The apparatus of claim 10, wherein the feature descriptors for the object are determined by applying scale invariant feature transforms.

17. The apparatus of claim 10, wherein the classification scores are computed using a support vector machine engine.

18. The apparatus of claim 10, wherein the object is tracked by partitioning of a temporal graph.
